(19) United States
(12) Patent Application Publication
(10) Pub. No.: US 2008/0223042 A1
(43) Pub. Date: Sep. 18, 2008

(54) DEVICE AND METHOD FOR A FIBER EVAPORATION ENGINE

(76) Inventor: Stephen J. Wiesner, Jerusalem (IL)

Correspondence Address: Naomi Assia.;c/o Landon IP, Inc., Suite 450, 1700 Diagonal Road, Alexandria, VA, 22314, US

(21) Appl. No.: 11/684,658

(22) Filed: Mar. 12, 2007

(51) Int. Cl. F03G 7/06

(52) U.S. Cl. 60/641.6

(57) ABSTRACT

An evaporation engine system for producing usable energy by application of alternate cycles of a cold liquid and available hot dry air. The system includes a vessel containing the cold liquid, a wheel partially submerged in the cold liquid, wherein the wheel is mounted on a first bearing on the crankshaft located at the axis of the wheel. The system also includes a second bearing on the crankshaft parallel to and fixed horizontally relative to the first bearing and a plurality of cords connected between the rim of the wheel and the second bearing, such that with each rotation of the wheel the plurality of cords dip into the cold liquid at the bottom of the rotation, wherein the plurality of cords shrink causing the plurality of cords come out again into the warm, dry air at the top of the rotation, wherein the plurality of cords become dry and as a result of the drying the plurality of cords lengthen, such that the rotation of the wheel becomes self-sustaining, wherein the rotation is available as an energy source.

### FIELD OF THE INVENTION

The present invention relates to a system and a method for an evaporation engine. More specifically, the present invention relates to an improved device and method for an evaporation engine using fiber and springs, for use as a primary source of power.

### BACKGROUND OF THE INVENTION

The world is running out of oil. Society is more and more dependent on the last big pools of oil, with consequences that are problematic for the U.S. and most of the rest of humanity. Every potential source of energy should be considered. Some sources have received extensive investigation, such as wind power, nuclear, hydro and solar.

Evaporation engines could supply vast amounts of power. Reference is made to an article by Zaslavsky on Philip Carlson's “Power Tower,” which is basically an as yet unfulfilled proposal for a multi-billion dollar development on a large scale, as shown in prior art FIG. 1. The article is entitled “Solar Energy Without a Collector for Electricity & Water in the 21st Century,” Professor Dan Zaslavsky, page 51 of Proceedings of the 8^{th} Sde Boqer symposium on Solar Electricity Production, 3-5 Nov. 1997. Editor, D. Faiman CEEP-98/11.

The technology, which was developed at the Technion, Israel's Institute of Technology, to produce electricity in arid lands, takes advantage of the region's predicament—a lot of hot and dry air, and turns it into an asset. A global cyclic air flow named after its discoverer, George Hadley, drives it to the desert belts between the 15th and the 35th latitude. Here the air descends and creates areas of arid lands and deserts. All over the world there are about 40 countries which have suitable climatic conditions.

For instance, compared to wind power, hydroelectric and bio-mass, evaporation energy is considered the most economical of all the technologies which are being developed to produce environmentally clean electricity using renewable sources. Moreover, it does not require a solar radiation collector and it works continuously day and night. Water, usually sea water or brackish water, will be sprayed into the top opening. The water will partially evaporate, thus cooling the air. The cool air is heavier and will sink down, producing an inverse chimney effect. When properly designed, the air will flow at high rates, powering turbines connected to electricity generators and escape through openings close to the base

Evaporation engines are also capable of producing very large quantities of energy, in fact an order of magnitude more than all the electricity produced today all over the world. Yet evaporation engines have received very little practical development effort, compared to other sources.

Feasibility has been repeatedly proven, using different methods reviewed by top outside experts. The physical principle has been correctly formulated and the net electricity output correctly computed. It has also been proven that evaporation engines can be built entirely based on proven technologies.

Colossal engines have been patented that turn by evaporating water. Zaslavsky, et al, in U.S. Pat. No. 6,510,687 disclose a renewable resource hydro/aero-power generation plant and method of generating hydro/aero-power. The power is generated from flowing air, utilizing a generally vertically extending duct having an inlet open to atmosphere at an elevation above an outlet. A spray system is mounted adjacent the inlet for spraying droplets of a predetermined amount of water into the air causing the air and droplet mixture to become cooler and denser than the outside air to create a down draft of fluid within the duct. A power system mounted adjacent the outlet recovers energy from the downdraft of fluid passing through it. The predetermined amount of water sprayed is greater than the amount of water that would theoretically and potentially evaporate in the air throughout the entire elevation over an unlimited time period using fresh water droplets.

The predetermined height of the duct is generally greater than about 100 meters, and preferably greater than about 500 meters.

Carlson, in U.S. Pat. No. 3,894,393, teaches power generation through controlled convection (aeroelectric power generation), wherein an enclosed air mass is cooled at high altitude below the temperature of the surrounding air. The air is isolated from the surrounding air by means of a large duct. The resulting cooler, denser air flows down the duct toward lower altitude, and the energy of the falling air mass is extracted by means of a turbine generator.

Several small engines have been built that turn by evaporating water. They work practically anyplace, but they work best under desert or near desert conditions of hot dry air. The water does not have to be fresh. It can be sea water or brackish water. According to the above referenced professor Zaslavsky of Israel's Technion Institute, on a world scale, vast amounts of energy, equivalent, at least, to tens of thousands of power stations, could be produced by evaporating sea water in the deserts. “If the engines were efficient, the energy produced would be the same as from dropping the evaporated water 5 to 10 thousand meters, more than the head of any hydroelectric plant.” By the the same calculation, each cubic meter of air passing through the engine can produce 200 to 400 joules of energy, so that there would be enough energy to push air through the engine at several meters per second. The air passing through the engine is cooled by the evaporation. Small engines could be used to cool a room. If evaporation was done on a large scale the air would be moistened and cooled, dew would be increased, and conditions in the desert for plant life and grazing animals would be improved.

Thus, there is a need for development of a practical, efficient evaporation engine, which can operate on both a large scale and a small scale.

### SUMMARY OF THE INVENTION

Accordingly, it is a principle object of the present invention to create an improved evaporation engine.

It is an other principle object of the present invention to provide an evaporation engine on a practical scale.

It is a further object of the present invention to provide an evaporation engine capable of producing a practical amount of recoverable energy.

An evaporation engine system is disclosed for producing usable energy by application of alternate cycles of a cold liquid and available hot dry air. The system includes a vessel containing the cold liquid, a wheel partially submerged in the cold liquid, wherein the wheel is mounted on a first bearing on the crankshaft located at the axis of the wheel. The system also includes a second bearing on the crankshaft parallel to and fixed horizontally relative to the first bearing and a plurality of cords connected between the rim of the wheel and the second bearing, such that with each rotation of the wheel the plurality of cords dip into the cold liquid at the bottom of the rotation, wherein the plurality of cords shrink causing the plurality of cords come out again into the warm, dry air at the top of the rotation, wherein the plurality of cords become dry and as a result of the drying the plurality of cords lengthen, such that the rotation of the wheel becomes self-sustaining, wherein the rotation is available as an energy source.

The present invention provides a simple evaporation engine, which could be used as a primary source of power.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTIONS OF THE DRAWINGS

For a better understanding of the invention in regard to the embodiments thereof, reference is made to the accompanying drawings and description, in which like numerals designate corresponding elements or sections throughout, and in which:

FIG. 1 shows a schematic illustration of an evaporation power tower, constructed to illustrate the principles of the prior art;

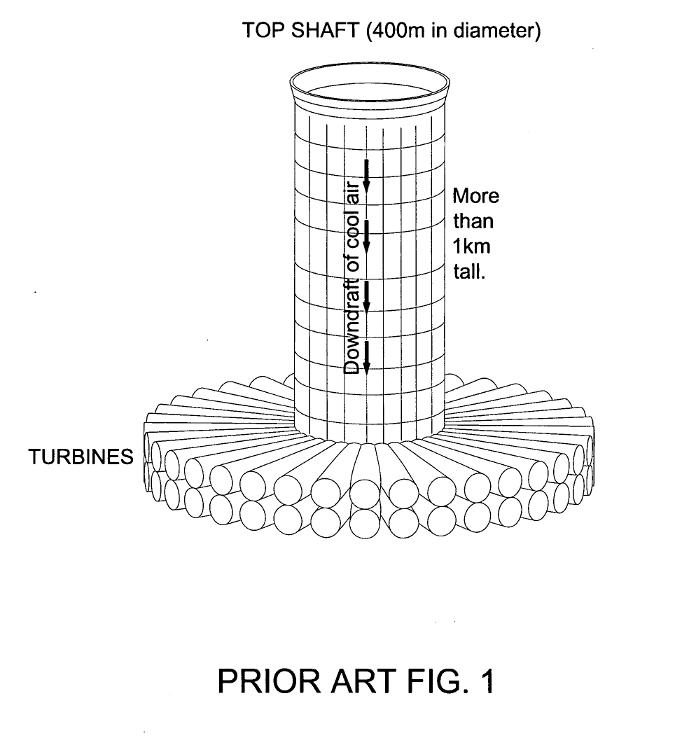

FIG. 2 is a schematic illustration of a side view of an improved evaporation engine design, constructed in accordance with the principles of the present invention;

FIG. 3 is a schematic illustration of a top view of an improved evaporation engine design, constructed in accordance with the principles of the present invention; and

FIG. 4 is a schematic illustration of an end view of an improved evaporation engine design, constructed in accordance with the principles of the present invention; and

FIG. 5 is a schematic illustration of a side view of an alternative embodiment of an improved evaporation engine design, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

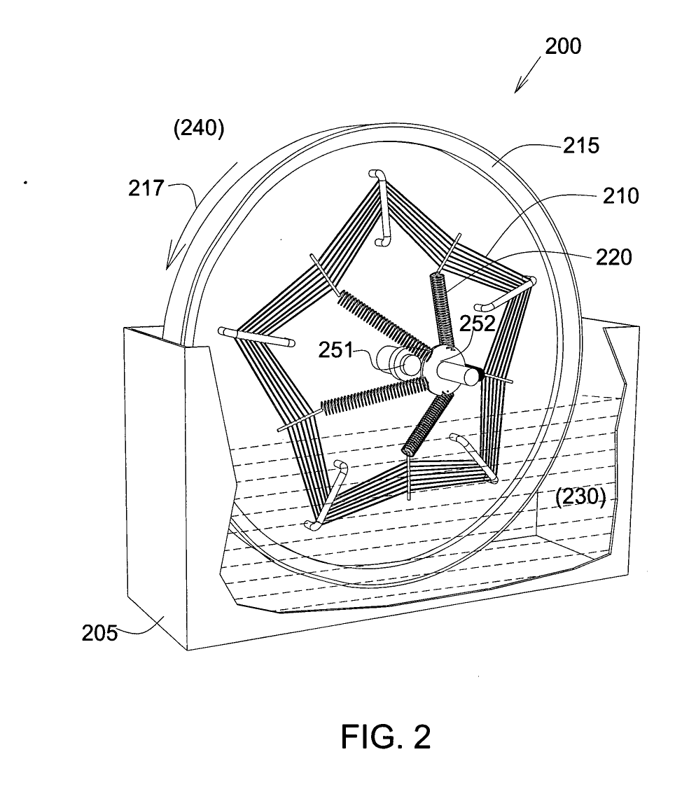

Reference is now made to FIG. 2, a schematic illustration of a side view of an improved evaporation engine design, constructed in accordance with the principles of the present invention.

The active elements of the engine 200 are cords 210, which shrink when they are wet and recover their length when they are dry. Cords 210 act like the pistons on a car. They are connected through springs 220 to a crankshaft. However, on this engine, the crankshaft is stationary and cords 210 are on a wheel 215, which rotates around the crankshaft. The crankshaft has a first bearing 251 at the axis of the wheel and a second bearing 252 on crankshaft 252 is parallel to and fixed horizontally relative to the first bearing. The direction of rotation 217 is shown.

As wheel 215 rotates, and cords 210 dip into a tank 205 partially filled with water 230, they shrink and move the obtuse vertices outward 270. Springs 220, in turn, also lengthen. Cords 210 then come out again into the warm, dry air 240, where they dry and lengthen, and the obtuse vertices move inward 260, and in turn springs 220 contract. Cords 210 need to be thin in order to dry quickly. On an exemplary preferred embodiment of the inventive engine, cords 210 are about 0.5 millimeters in diameter. Warm, dry air 240 is at about 30 degrees centigrade (86° F.) and 30 percent humidity and moving at about 1.5 meters per second. Engine 200 takes about 5 minutes or 300 seconds to make one revolution.

In more extreme desert conditions wheel 215 would go faster, but the biggest improvement should come from making cords 210 thinner. If cords 210 were 10 times thinner, they would dry about 30 times faster and engine 200 should go around in about 10 seconds, with a corresponding increase in energy output. Earlier engines had thicker cords and this kind of speedup, as predicted by theory, has been shown to hold. Preferably, engines with even thinner cords can be provided by the professional textile industry.

In a preferred embodiment, cords 210 are made by taking thin cotton yarn, doubling it, and twisting the two strands until the length decreases 20%. The twisted cord is again doubled and twisted until the length again decreases 20%. The basic effect is that the cotton fibers swell when wet. This causes the twisted yarn to shrink.

Cotton was used largely because thin yarn was available. It would be nice to try other natural fibers. Common synthetic yarns do not hold water well. However, there are synthetic polymers that are strong and very hydrophilic. If these were made into yarns they could be superior to natural fibers.

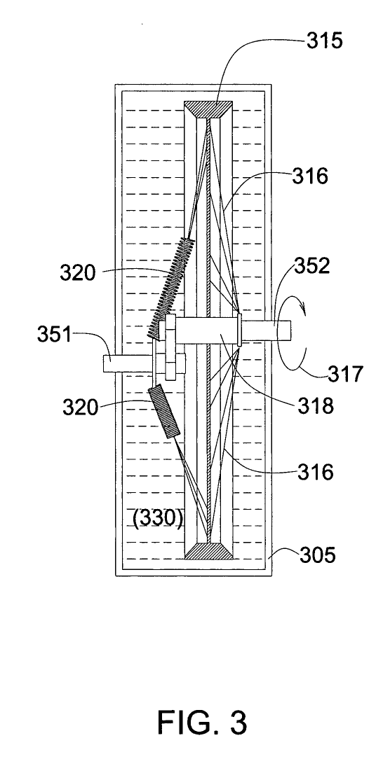

FIG. 3 is a schematic illustration of a top view of an improved evaporation engine design, constructed in accordance with the principles of the present invention. Again, wheel 315 is seen in a tank 305, partially immersed in water 330. In an exemplary embodiment, wheel 315 is a bicycle wheel, having spokes 316, and the direction of rotation 317 is as shown. Thus, the crankshaft 318 has a first bearing 351 at the axis of wheel 315 and a second bearing 352 on the crankshaft is parallel to and fixed horizontally relative to first bearing 351, as described in reference to FIG. 2. Crankshaft 318 is, optionally attached to wheel 315 by springs 320.

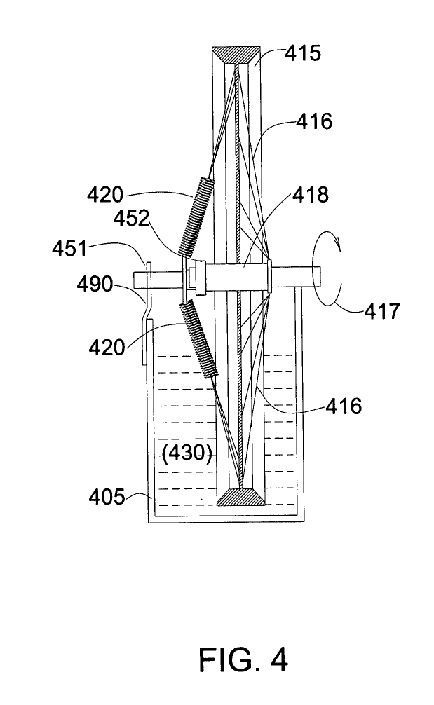

FIG. 4 is a schematic illustration of an end view of an improved evaporation engine design, constructed in accordance with the principles of the present invention. Again, wheel 415 is seen in a tank 405, partially immersed in water 430. In an exemplary embodiment, wheel 415 is a bicycle wheel, having spokes 416, and the direction of rotation 417 is as shown. A crankshaft 418 has connecting wheel bearings 451 and 452. Crankshaft 418 is optionally attached to wheel 415 by springs 420. Crankshaft 418 is attached to tank 415 by an offset bracket 490.

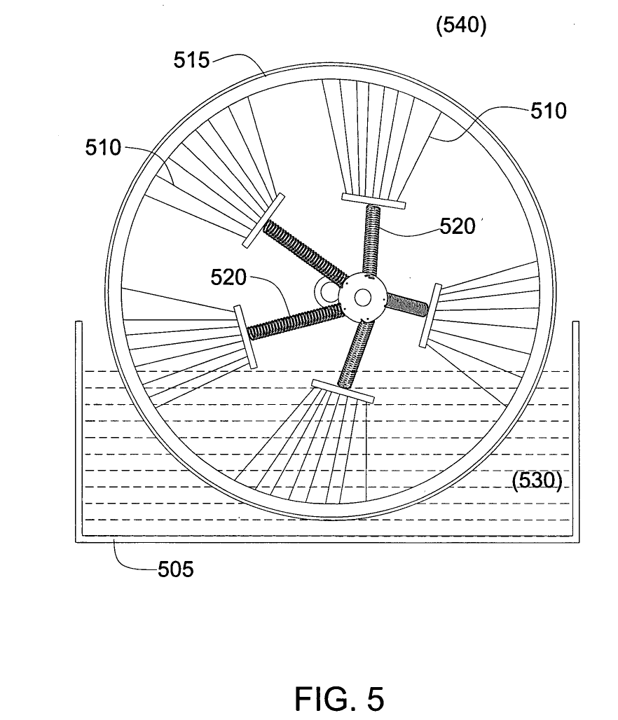

FIG. 5 is a schematic illustration of a side view of an alternative embodiment of an improved evaporation engine design, constructed in accordance with the principles of the present invention. In this embodiment the cords 510 are radial, and again are attached to a wheel 515. The direction of rotation 517 is shown. As wheel 515 rotates, cords 510 dip into a tank 505, partially filled with water 530. There they shrink and lengthen springs 520. Cords 510 then come out again into the warm, dry air 540, where they dry and lengthen, allowing springs 520 to contract.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. An evaporation engine system for producing usable energy by application of alternate cycles of a cold liquid and available hot dry air, said system comprising:
a vessel containing the cold liquid;
a wheel partially submerged in said cold liquid, said wheel mounted on a first bearing on the crankshaft located at the axis of said wheel;
a second bearing on said crankshaft parallel to and fixed horizontally relative to said first bearing; and
a plurality of cords connected between the rim of said wheel and said second bearing,
such that with each rotation of said wheel, said plurality of cords dip into said cold liquid at the bottom of the rotation, wherein said plurality of cords shrink causing said plurality of cords to come out again into the warm, dry air at the top of the rotation, wherein said plurality of cords become dry, and as a result of said drying said plurality of cords lengthen, such that the rotation of said wheel becomes self-sustaining, wherein said rotation is available as an energy source.

2. The evaporation engine system of claim 1, wherein said cold liquid is water.

3. The evaporation engine system of claim 1, wherein said plurality of cords are made of thin cotton yarn.

4. The evaporation engine system of claim 3, wherein said thin cotton yarn is doubled.

5. The evaporation engine system of claim 4, wherein said doubled thin cotton yarn is twisted, thereby decreasing the length of said yarn

6. The evaporation engine system of claim 5, wherein said twisted doubled thin cotton yarn is again twisted and again doubled, thereby further decreasing the length of said yarn, such that the cotton fibers swell when wet, thereby causing the twisted yarn to shrink.

7. The evaporation engine system of claim 1, further comprising at least one spring between said plurality of cords and said second bearing.

8. The evaporation engine system of claim 1, wherein said plurality of cords is made from a material that shrinks upon drying and lengthens upon becoming wet.

9. The evaporation engine system of claim 1, wherein said system is applicable to make air cooler.

10. The evaporation engine system of claim 1, wherein said system is applicable to humidify air.

11. The evaporation engine system of claim 1, wherein said system is applicable to concentrate a fluid.

12. The evaporation engine system of claim 1, wherein said system is applicable to aerate water.

13. The evaporation engine system of claim 1, wherein said system is applicable as an ornament.

14. The evaporation engine system of claim 1, wherein said system is applicable as a toy.
